(19) United States
(12) Patent Application Publication
(10) Pub. No.: US 2025/0028138 A1
(43) Pub. Date: Jan. 23, 2025

(54) OPTICAL ELEMENT DRIVING MECHANISM

(71) Applicant: TDK TAIWAN CORP., Taoyuan City (TW)

(72) Inventors: Ya-Hsiu WU, Taoyuan City (TW); Kai-Po FAN, Taoyuan City (TW); Ying-Jen WANG, Taoyuan City (TW); Sin-Jhong SONG, Taoyuan City (TW)

(21) Appl. No.: 18/778,153

(22) Filed: Jul. 19, 2024

Related U.S. Application Data
(60) Provisional application No. 63/514,958, filed on Jul. 21, 2023.

(51) Int. Cl. G02B 7/00; G02B 13/00; H04N 23/68

(52) U.S. Cl. CPC G02B 7/005; G02B 13/001; H04N 23/685; G03B 2205/0069

(57) ABSTRACT

An optical element driving mechanism is provided, including a first movable part, a fixed part, and a first driving assembly. The first movable part is connected to a first optical element. The first movable part is movable relative to the fixed part. The first driving assembly drives the first movable part to move.

### CROSS REFERENCE TO RELATED APPLICATIONS

This application claims the benefit of U.S. Provisional Application No. 63/514,958, filed Jul. 21, 2023, the entirety of which is incorporated by reference herein.

### BACKGROUND OF THE INVENTION

### Field of the Invention

The present disclosure relates to an optical element driving mechanism, and more specifically, the present disclosure relates to an optical element driving mechanism for an electronic device.

### Description of the Related Art

As the relevant technologies have been developed, many electronic devices (such as computers and tablets) are equipped with the capability to record images and videos. However, when an optical element (such as lens) having a long focal length is provided in an electronic device, the thickness of the electronic device may be increased, impeding the prospects for miniaturization of the electronic device. Therefore, how to design an optical element driving mechanism and an optical device that may miniaturize the electronic device has become an important issue.

### BRIEF SUMMARY OF THE INVENTION

An embodiment of the present invention provides an optical element driving mechanism, including a first movable part, a fixed part, and a first driving assembly. The first movable part is connected to a first optical element. The first movable part is movable relative to the fixed part. The first driving assembly drives the first movable part to move.

### BRIEF DESCRIPTION OF THE DRAWINGS

The present invention may be more fully understood by reading the subsequent detailed description and examples with references made to the accompanying drawings, wherein:

FIG. 1 is a schematic view of an electrical device according to some embodiment of the present disclosure;

FIG. 2 is a schematic view of the optical element driving mechanism, the first optical element, and the second optical element according to some embodiments of the present disclosure, in which the outer frame is represented by a dotted line;

FIG. 3 is an exploded view of the optical element driving mechanism, the first optical element, and the second optical element according to some embodiments of the present disclosure;

FIG. 4 is a cross-sectional view along line A-A′ of FIG. 2 of the optical element driving mechanism, the first optical element and the second optical element according to some embodiments of the present disclosure;

FIG. 5 is a cross-sectional view along line B-B′ of FIG. 2 of the optical element driving mechanism, the first optical element and the second optical element according to some embodiments of the present disclosure;

FIG. 6 is a cross-sectional view along line C-C′ of FIG. 2 of the optical element driving mechanism, the first optical element and the second optical element according to some embodiments of the present disclosure;

FIG. 7 is a cross-sectional view along line D-D′ of FIG. 2 of the optical element driving mechanism, the first optical element and the second optical element according to some embodiments of the present disclosure;

FIG. 8 is a cross-sectional view along line E-E′ of FIG. 2 of the optical element driving mechanism, the first optical element and the second optical element according to some embodiments of the present disclosure;

FIG. 9 is a cross-sectional view along line F-F′ of FIG. 2 of the optical element driving mechanism, the first optical element and the second optical element according to some embodiments of the present disclosure;

FIG. 10 is a modified embodiment of the optical element driving mechanism 100, the first optical element and the second optical element in FIG. 8;

FIG. 11 is a top view of the optical element driving mechanism, the external device, the first optical element and the second optical element according to some embodiments of the present disclosure;

FIG. 12 is a cross-sectional view along line G-G′ of FIG. 2 of the optical element driving mechanism, the first optical element and the second optical element according to some embodiments of the present disclosure;

FIG. 13 is a cross-sectional view along line H-H′ of FIG. 2 of the optical element driving mechanism, the first optical element and the second optical element according to some embodiments of the present disclosure;

FIG. 14 is a perspective view of the reinforcing assembly of the optical element driving mechanism according to some embodiments of the present disclosure.

### DETAILED DESCRIPTION OF THE INVENTION

The making and using of optical systems of embodiments of the present disclosure are discussed in detail below. It should be appreciated, however, that the embodiments provide many applicable inventive concepts that may be embodied in a wide variety of specific contexts. The specific embodiments discussed are merely illustrative of specific ways to make and use the embodiments and do not limit the scope of the disclosure.

It should be understood that, although the terms “first”, “second” etc. may be used herein to describe various elements, layers and/or portions, and these elements, layers, and/or portions should not be limited by these terms. These terms are only used to distinguish one element, layer, or portion. Thus, a first element, layer or portion discussed below could be termed a second element, layer or portion without departing from the teachings of some embodiments of the present disclosure. In addition, for the sake of brevity, terms such as “first” and “second” may not be used in the description to distinguish different elements. As long as it does not depart from the scope defined by the appended claims, the first element and/or the second element described in the appended claims can be interpreted as any element that meets the description in the specification.

It should be noted that the technical solutions provided by different embodiments below may be interchangeable, combined or mixed to form another embodiment without departing from the spirit of the present disclosure.

Unless defined otherwise, all technical and scientific terms used herein have the same meaning as commonly understood by one of ordinary skill in the art to which this disclosure belongs. It should be appreciated that each term, which is defined in a commonly used dictionary, should be interpreted as having a meaning conforming to the relative skills and the background or the context of the present disclosure, and should not be interpreted in an idealized or overly formal manner unless defined otherwise.

The scale of the drawings in the present disclosure may be drawn according to the actual size. The scale of the same figure in the present disclosure can be used as the actual manufacturing scale of the devices, equipment, elements, etc. of the present disclosure. It should be noted that each figure may be drawn at different orientations, which may result in different size ratios among different figures. However, the size ratio shown in an individual figure is not affect by the different size ratios between different figures. People with ordinary skill in the art can understand that the size ratio of the figures in the present disclosure can be used as a distinguishing feature from the prior art.

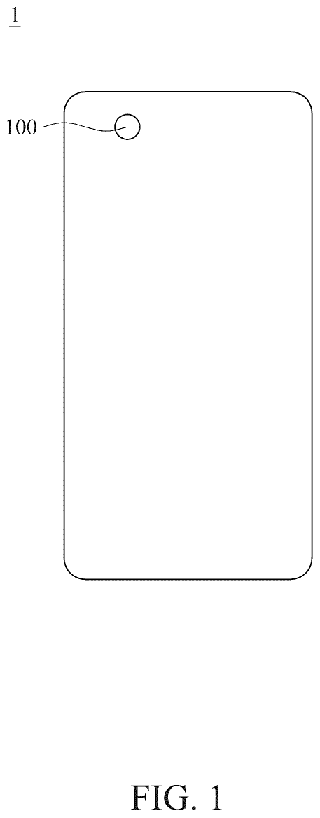

Firstly, please refer to FIG. 1, FIG. 1 is a schematic view of an electrical device 1 according to some embodiment of the present disclosure. As shown in FIG. 1, an optical system 100 of some embodiment of the present disclosure may be mounted in an electrical device 1 for taking photos or videos, wherein the aforementioned electrical device 1 may, for example, be a smartphone or a digital camera, but the present disclosure is not limited to these. It should be noted that the position and the size between the optical system 100 and the electrical device 1 shown in FIG. 1 are only an example, which is not for limiting the position and the size between the optical system 100 and the electrical device 1. In fact, according to different needs, the optical system 100 may be mounted at different positions in the electrical device 1.

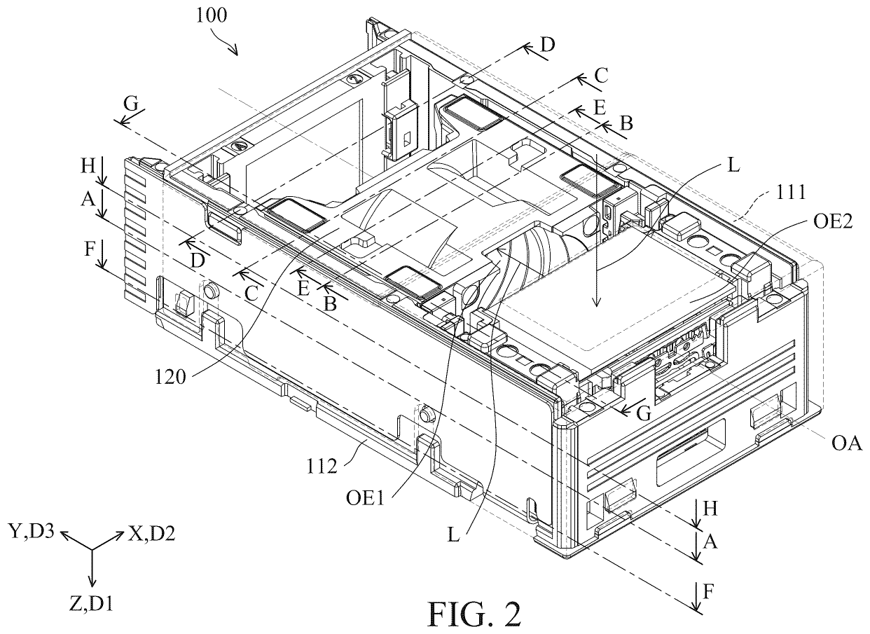

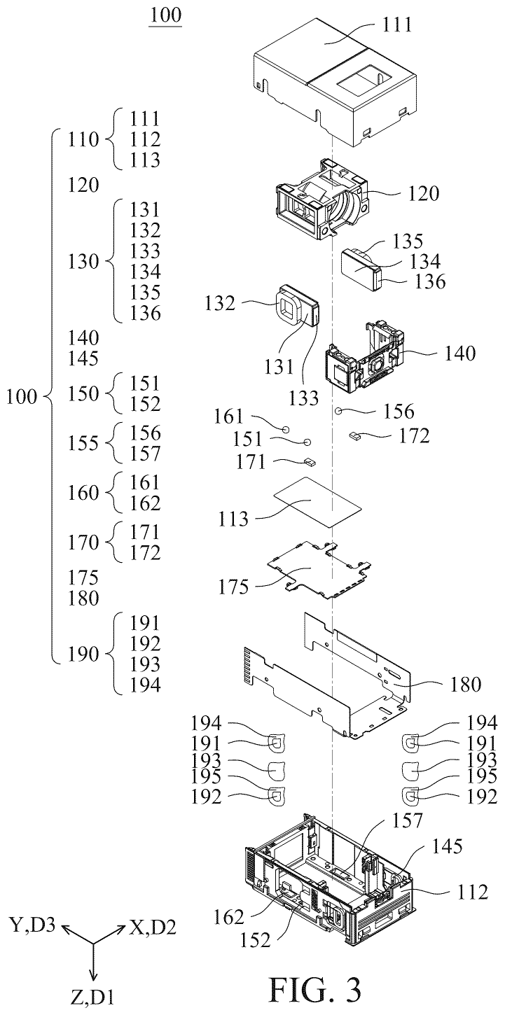

Please refer to FIG. 2 and FIG. 3. FIG. 2 is a schematic view of the optical element driving mechanism 100, the first optical element OE1, and the second optical element OE2 according to some embodiments of the present disclosure, in which the outer frame 111 is represented by a dotted line. FIG. 3 is an exploded view of the optical element driving mechanism 100, the first optical element OE1, and the second optical element OE2 according to some embodiments of the present disclosure.

The optical element driving mechanism 100 may include a fixed part 110, a first movable part 120, a first driving assembly 130, a second movable part 140, a second driving assembly 145, a first supporting assembly 150, a second supporting assembly 155, a third supporting assembly 160, a stabilizing assembly 170, a reinforcing assembly 175, a circuit assembly 180, and a connecting assembly 190.

The fixed part 110 may include an outer frame 111, a base 112, and a fixed part magnetic conductive element 113. The outer frame 111 is disposed on the base 112, and the outer frame 111 and the base 112 may be connected to each other to form an internal space to accommodate other elements of the optical element driving mechanism 100 or the first optical element OE1 and the second optical element OE2.

As shown in FIG. 2, a light L may be incident to the second optical element OE2 from the outside of the optical element driving mechanism 100 along a first direction D1. The second optical element OE2 refracts and/or reflects the light L from the first direction D1 to be incident to the first optical element OE1 along the optical axis OA (which may also be the third direction D3 that is perpendicular to the first direction D1).

The first movable part 120 may be connected to the first optical element OE1, and the first movable part 120 may move relative to the fixed part 110. For example, the first movable part 120 may move along the optical axis OA relative to the fixed part 110, and the first optical element OE1 may move along the optical axis OA relative to the fixed part 110 along with the first movable part 120.

The first driving assembly 130 may drive the first movable part 120 to move relative to the fixed part 110. The first driving assembly 130 may include a first driving magnet 131, a first driving coil 132, a first magnetic isolation element 133, a second driving magnet 134, a second driving coil 135, and a second magnetic isolation element. 136.

The first driving magnet 131 and the second driving magnet 134 may be disposed on the first movable part 120, and the first driving coil 132 and the second driving coil 135 may be disposed on the base 112, so that when the first driving coil 132 and the second driving coil 135 receives the current from the circuit assembly 180, the first driving magnet 131 and the second driving magnet 134 drive the first movable part 120 to move along the optical axis OA relative to the fixed part 110.

The first magnetic isolation element 133 corresponds to the first driving magnet 131, and the second magnetic isolation element 136 corresponds to the second driving magnet 134. For example, the first magnetic isolation element 133 may be disposed adjacent to the first driving magnet 131 or attached to the first driving magnet 131, and the second magnetic isolation element 136 may be disposed adjacent to the second driving magnet 134 or attached to the second driving magnet 134.

The first magnetic isolating element 133 and the second magnetic isolating element 136 may be made of magnetically conductive material to prevent the magnetic force of the first driving magnet 131 and/or the second driving magnet 134 from leaking, thereby avoiding unwanted magnetic influence to other elements of the optical element driving mechanism 100 or external devices.

The second movable part 140 may be connected to the second optical element OE2, and the second movable part 140 may move relative to the fixed part 110. For example, the second movable part 140 may rotate relative to the fixed part 110 around the first direction D1 and/or the second direction D2 that are perpendicular to the optical axis OA, and the second optical element OE2 may move along with the second movable part 140 to rotate around the first direction D1 and/or the second direction D2 relative to the fixed part 110.

The second driving assembly 145 drives the second movable part 140 to move relative to the fixed part 110. When the second driving assembly 145 receives the current from the circuit assembly 180, the second driving assembly 145 drives the second movable part 140 to rotate relative to the fixed part 110 around the first direction D1 and/or the second direction D2.

The first supporting assembly 150, the second supporting assembly 155, and the third supporting assembly 160 may support the first movable part 120 so that the first movable part 120 may move along the optical axis OA relative to the fixed part 110.

The stabilizing assembly 170 stabilizes the first movable part 120. The stabilizing assembly 170 includes a first stabilizing element 171 and a second stabilizing element 172.

The reinforcing assembly 175 is made of metal, and the reinforcing assembly 175 may be embedded in the base 112 to reinforce the structure of the base 112.

The circuit assembly 180 is directly or indirectly connected to an external circuit to supply current to other elements of the optical element driving mechanism 100, such as the first driving coil 132 and the second driving coil 135 of the first driving assembly 130, and the second driving assembly 145.

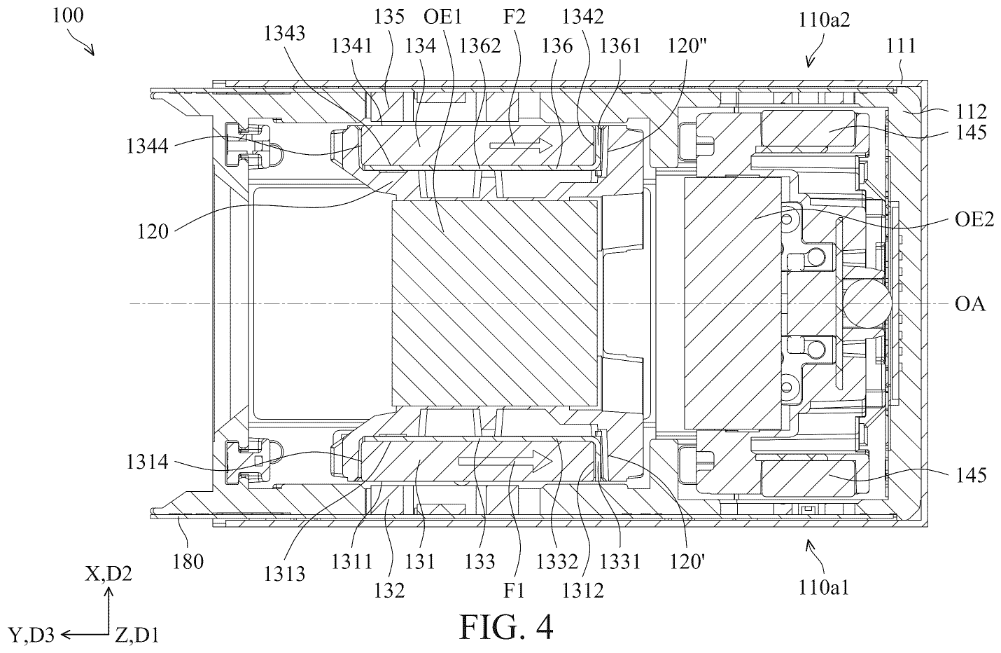

Please refer to FIG. 4. FIG. 4 is a cross-sectional view along line A-A′ of FIG. 2 of the optical element driving mechanism 100, the first optical element OE1 and the second optical element OE2 according to some embodiments of the present disclosure.

As shown in FIG. 4, when viewed along the first direction D1 that is perpendicular to the optical axis OA, the fixed part 110 has a polygonal structure, and the polygonal structure includes a first side 110a1 and a second side 110a2. The first side 110a1 and the second side 110a2 of the fixed part 110 extend along the optical axis OA. When viewed along the first direction D1, the first side 110a1 and the second side 110a2 of the fixed part 110 are located on both sides of the optical axis OA, respectively.

The first driving magnet 131, the first driving coil 132, and the first magnetic isolation element 133 are located between the optical axis OA and the first side 110a1. Moreover, the distance between the first driving magnet 131, the first driving coil 132, and the first magnetic isolation element 133 and the first side 110a1 is smaller than the distance between the first driving magnet 131, the first driving coil 132, and the first magnetic isolation element 133 and the second side 110a2. That is, the first driving magnet 131, the first driving coil 132, and the first magnetic isolation element 133 are disposed close to the first side 110a1 and away from the second side 110a2.

The second driving magnet 134, the second driving coil 135, and the second magnetic isolation element 136 are located between the optical axis OA and the second side 110a2. Moreover, the distance between the second driving magnet 134, the second driving coil 135, and the second magnetic isolation element 136 and the second side 110a2 is smaller than the distance between the second driving magnet 134, the second driving coil 135, and the second magnetic isolation element 136 and the first side 110a1. That is, the second driving magnet 134, the second driving coil 135, and the second magnetic isolation element 136 are disposed close to the second side 110a2 and away from the first side 110a1.

When a first driving current from the circuit assembly 180 is input to the first driving coil 132 of the first driving assembly 130, the first driving assembly 130 generates a first driving force (indicated by an arrow) F1 and exerts force on a first force bearing part 120′ of the first movable part 120.

When viewed along the first direction D1, the first force bearing part 120′ is located between the first side 110a1 of the fixed part 110 and the optical axis OA. It is conceivable that when viewed along the first direction D1, the first force bearing part 120′ and the first driving magnet 131 overlap each other, so that the first driving force F1 may stably and effectively drive the first movable part 120. Therefore, the distance between the first force bearing part 120′ and the first side 110a1 is smaller than the distance between the first force bearing part 120′ and the second side 110a2. That is, the first force bearing part 120′ is close to the first side 110a1 and away from the second side 110a2.

When the first driving current from the circuit assembly 180 is input to the second driving coil 135 of the first driving assembly 130, the first driving assembly 130 generates a second driving force (indicated by an arrow) F2 and exerts force on the second force bearing part 120″ of the first movable part 120.

When viewed along the first direction D1, the second force bearing part 120″ is located between the second side 110a2 of the fixed part 110 and the optical axis OA. It is conceivable that when viewed along the first direction D1, the second force bearing part 120″ and the second driving magnet 134 overlap each other, so that the second driving force F2 may drive the first movable part 120 stably and effectively. Therefore, the distance between the second force bearing part 120″ and the second side 110a2 is smaller than the distance between the second force bearing part 120″ and the first side 110a1. That is, the second force bearing part 120″ is close to the second side 110a2 and away from the first side 110a1.

According to some embodiments of the present disclosure, the magnetic strength of the first driving magnet 131 is different from the magnetic strength of the second driving magnet 134. In detail, according to some embodiments of the present disclosure, the magnetic strength of the first driving magnet 131 is greater than the magnetic strength of the second driving magnet 134.

According to some embodiments of the present disclosure, the intensity of the first driving force F1 is different from the intensity of the second driving force F2. According to some embodiments of the present disclosure, the intensity of the first driving force F1 is greater than the intensity of the second driving force F2.

Please continue to refer to FIG. 4. The first driving magnet 131 includes a first driving magnet first surface 1311, a first driving magnet second surface 1312, a first driving magnet third surface 1313, and a first driving magnet fourth surface 1314.

When viewed along the first direction D1, the first magnetic isolation element 133 has an L shape, and the first magnetic isolation element 133 includes a first magnetic isolation element first magnetic isolation part 1331, and a first magnetic isolation element second magnetic isolation part 1332.

The first magnetic isolation element first magnetic isolation part 1331 and the first magnetic isolation element second magnetic isolation part 1332 have plate-like structures, and the first magnetic isolation element first magnetic isolation part 1331 and the first magnetic isolation element second magnetic isolation part 1332 are parallel to the first direction D1 (In other words, the first magnetic isolation element first magnetic isolation part 1331 and the first magnetic isolation element second magnetic isolation part 1332 do not face the first direction D1). However, the first magnetic isolation element first magnetic isolation part 1331 and the first magnetic isolation element second magnetic isolation part 1332 are not parallel to each other. In detail, the first magnetic isolation element first magnetic isolation part 1331 is perpendicular to the optical axis OA, and the first magnetic isolation element second magnetic isolation part 1332 is perpendicular to the second direction D2. That is, the first magnetic isolation element first magnetic isolation part 1331 is perpendicular to the first magnetic isolation element second magnetic isolation part 1332.

The first driving magnet first surface 1311 faces the first driving coil 132, and the first driving magnet first surface 1311 is perpendicular to the second direction D2.

The first driving magnet second surface 1312 faces the first magnetic isolation element first magnetic isolation part 1331 of the first magnetic isolation element 133, and first driving magnet second surface 1312 is perpendicular to the optical axis OA.

The first driving magnet third surface 1313 faces the first magnetic isolation element second magnetic isolation part 1332 of the first magnetic isolation element 133, and the first driving magnet third surface 1313 is perpendicular to the second direction D2.

The first magnetic isolation element 133 does not correspond to the first driving magnet fourth surface 1314, and the first driving magnet fourth surface 1314 is perpendicular to the optical axis OA.

The first magnetic isolation element first magnetic isolation part 1331 is between the first driving magnet 131 and the second driving assembly 145.

When viewed along the optical axis OA, the first magnetic isolation element first magnetic isolation part 1331 at least partially overlaps the first driving magnet 131.

When viewed along the optical axis OA, the first magnetic isolation element second magnetic isolation part 1332 does not overlap with the first driving magnet 131.

When viewed along the first direction D1, the first magnetic isolation element first magnetic isolation part 1331 does not overlap with the first driving magnet 131, and the first magnetic isolation element second magnetic isolation part 1332 does not overlap with the first driving magnet 131.

When viewed along the direction that is perpendicular to the first driving magnet first surface 1311 (the second direction D2), the first magnetic isolation element first magnetic isolation part 1331 does not overlap with the first driving magnet 131.

When viewed along the direction that is perpendicular to the first driving magnet first surface 1311 (the second direction D2), the first magnetic isolation element second magnetic isolation part 1332 at least partially overlaps the first driving magnet 131.

Please continue to refer to FIG. 4. The second driving magnet 134 includes a second driving magnet first surface 1341, a second driving magnet second surface 1342, a second driving magnet third surface 1343, and a second driving magnet fourth surface 1344.

When viewed along the first direction D1, the second magnetic isolation element 136 has an L shape, and the second magnetic isolation element 136 includes a second magnetic isolation element first magnetic isolation part 1361, and a second magnetic isolation element second magnetic isolation part 1362.

The second magnetic isolation element first magnetic isolation part 1361 and the second magnetic isolation element second magnetic isolation part 1362 have plate-like structures, and second magnetic isolation element first magnetic isolation part 1361 and the second magnetic isolation element second magnetic isolation part 1362 are parallel to the first direction D1 (in other words, second magnetic isolation element first magnetic isolation part 1361 and the second magnetic isolation element second magnetic isolation part 1362 do not face the first direction D1). However, the second magnetic isolation element first magnetic isolation part 1361 and the second magnetic isolation element second magnetic isolation part 1362 are not parallel to each other. In detail, the second magnetic isolation element first magnetic isolation part 1361 is perpendicular to the optical axis OA, and the second magnetic isolation element second magnetic isolation part 1362 is perpendicular to the second direction D2. That is, the second magnetic isolation element first magnetic isolation part 1361 is perpendicular to the second magnetic isolation element second magnetic isolation part 1362.

The second driving magnet first surface 1341 faces the second driving coil 135, and the second driving magnet first surface 1341 is perpendicular to the second direction D2.

The second driving magnet second surface 1342 faces the second magnetic isolation element first magnetic isolation part 1361 of the second magnetic isolation element 136, and the second driving magnet second surface 1342 is perpendicular to the optical axis OA.

The second driving magnet third surface 1343 faces the second magnetic isolation element second magnetic isolation part 1362 of the second magnetic isolation element 136, and the second driving magnet third surface 1343 is perpendicular to the second direction D2.

The second magnetic isolation element 136 does not correspond to the second driving magnet fourth surface 1344, and the second driving magnet fourth surface 1344 is perpendicular to the optical axis OA.

The second magnetic isolation element first magnetic isolation part 1361 is between the second driving magnet 134 and the second driving assembly 145.

When viewed along the optical axis OA, the second magnetic isolation element first magnetic isolation part 1361 and the second driving magnet 134 at least partially overlap each other.

When viewed along the optical axis OA, the second magnetic isolation element second magnetic isolation part 1362 and the second driving magnet 134 do not overlap.

When viewed along the first direction, the second magnetic isolation element first magnetic isolation part 1361 does not overlap with the second driving magnet 134, and the second magnetic isolation element second magnetic isolation part 1362 does not overlap with the second driving magnet 134.

When viewed along the direction perpendicular to the second driving magnet first surface 1341 (second direction D2), the second magnetic isolation element first magnetic isolation part 1361 does not overlap with the second driving magnet 134.

When viewed along the direction perpendicular to the second driving magnet first surface 1341 (second direction D2), the second magnetic isolation element second magnetic isolation part 1362 at least partially overlaps the second driving magnet 134.

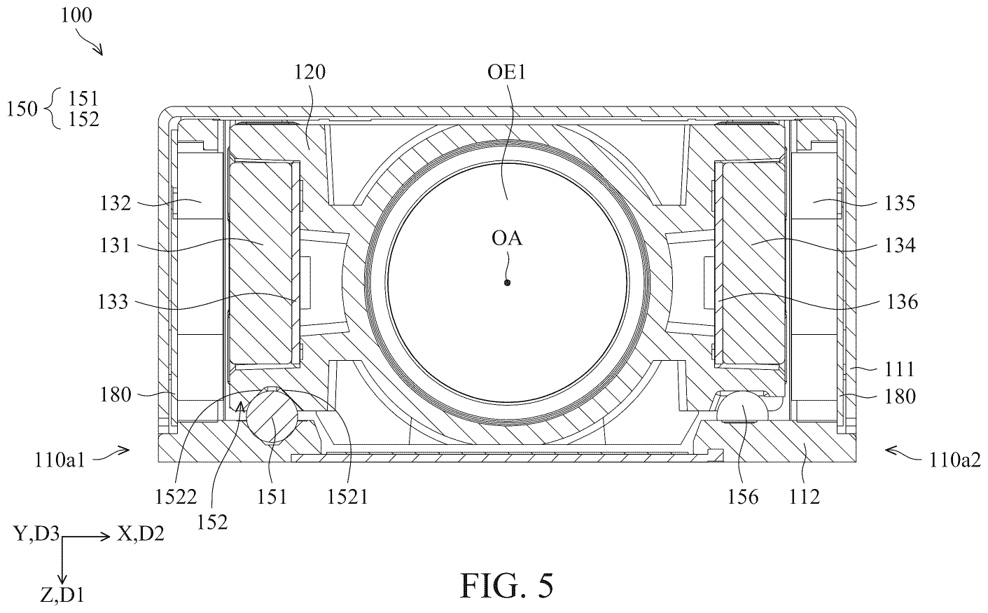

Please refer to FIG. 5. FIG. 5 is a cross-sectional view along line B-B′ of FIG. 2 of the optical element driving mechanism 100, the first optical element OE1 and the second optical element OE2 according to some embodiments of the present disclosure.

The first supporting assembly 150 includes a first intermediate element 151 and a first supporting portion 152. The first intermediate element 151 may have a spherical shape, for example, the first intermediate element 151 may be a ball. The first supporting portion 152 corresponds to the first intermediate element 151, and the first intermediate element 151 is movable relative to the first supporting portion 152. For example, the first intermediate element 151 may move along the optical axis OA relative to the first supporting portion 152.

The first supporting portion 152 may be located on the first movable part 120. The first supporting portion 152 includes a first supporting portion first surface 1521 and a first supporting portion second surface 1522. The first supporting portion first surface 1521 and the first supporting portion second surface 1522 face different directions, and both the first supporting portion first surface 1521 and the first supporting portion second surface 1522 are in direct contact with the first intermediate element 151.

When viewed along the first direction D1, the first supporting assembly 150 is located between the first side 110a1 of the fixed part 110 and the optical axis OA. The distance between the first supporting assembly 150 and the first side 110a1 is smaller than the distance between the first supporting assembly 150 and the second side 110a2. That is, the first supporting assembly 150 is close to the first side 110a1 and away from the second side 110a2.

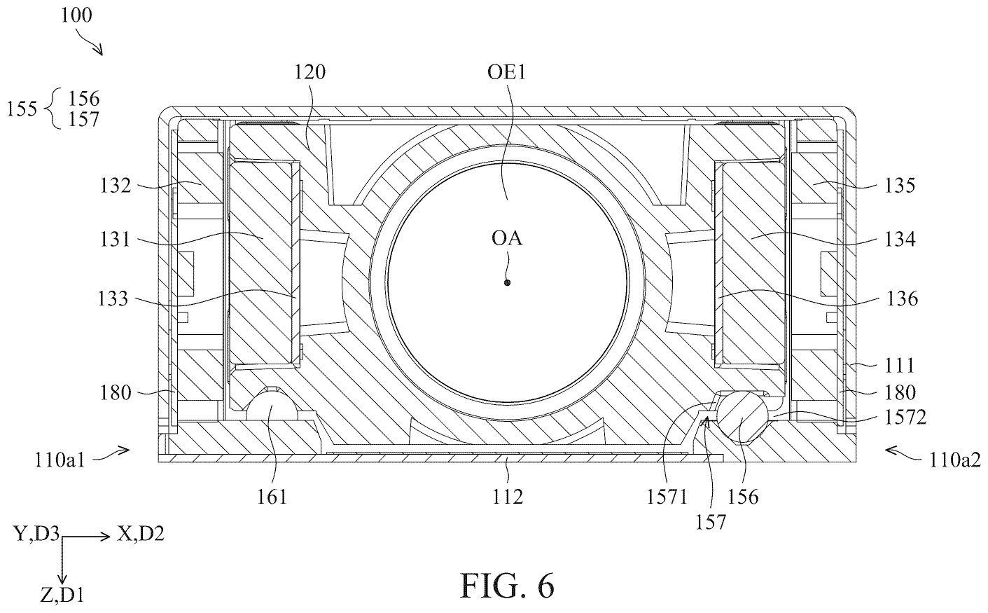

Please refer to FIG. 6. FIG. 6 is a cross-sectional view along line C-C′ of FIG. 2 of the optical element driving mechanism 100, the first optical element OE1 and the second optical element OE2 according to some embodiments of the present disclosure.

The second supporting assembly 155 includes a second intermediate element 156 and a second supporting portion 157. The second intermediate element 156 may have a spherical shape, for example, the second intermediate element 156 may be a ball. The second supporting portion 157 corresponds to the second intermediate element 156, and the second intermediate element 156 is movable relative to the second supporting portion 157. For example, the second intermediate element 156 may move along the optical axis OA relative to the second support 157.

The second supporting portion 157 may be located on the first movable part 120. The second supporting portion 157 includes a second supporting portion surface 1571 and a second supporting portion opening 1572. The second supporting portion surface 1571 is in direct contact with the second intermediate element 156. The second supporting portion surface 1571 faces different directions from the first supporting portion first surface 1521 and the first supporting portion second surface 1522.

The second supporting portion opening 1572 is adjacent to the second supporting portion surface 1571, such that the second supporting portion surface 1571 is “broken” near the second side 110a2 of the fixed part 110.

In this way, it may be helpful to assemble the optical element driving mechanism 100. Furthermore, the optical element driving mechanism 100 may be made lighter and smaller.

When viewed along the first direction D1, the second supporting assembly 155 is located between the second side 110a2 of the fixed part 110 and the optical axis OA. The distance between the second supporting assembly 155 and the first side 110a2 is smaller than the distance between the second supporting assembly 155 and the first side 110a1. That is, the second supporting assembly 155 is close to the second side 110a2 and away from the first side 110a1.

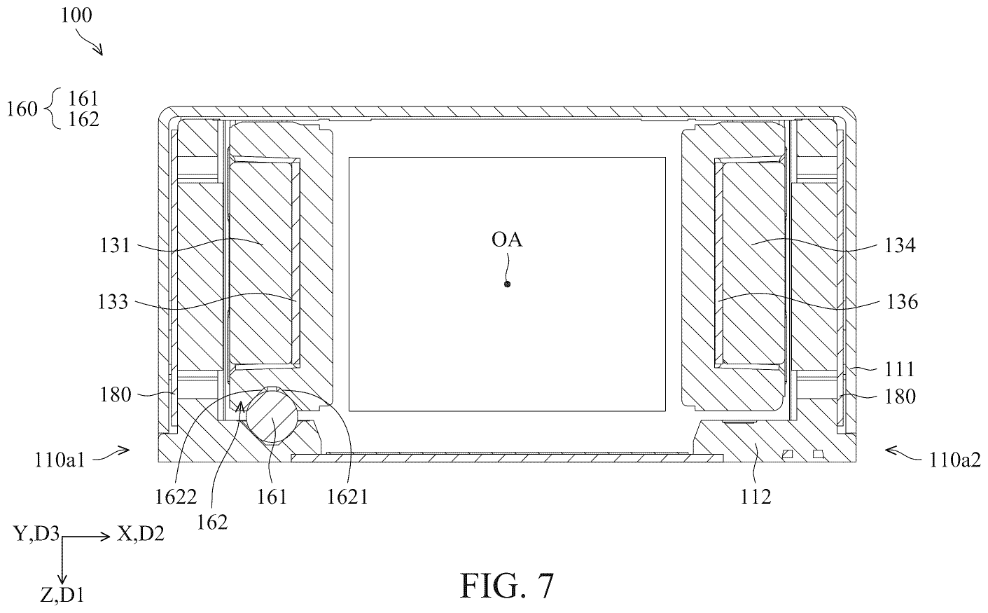

Please refer to FIG. 7. FIG. 7 is a cross-sectional view along line D-D′ of FIG. 2 of the optical element driving mechanism 100, the first optical element OE1 and the second optical element OE2 according to some embodiments of the present disclosure.

The third supporting assembly 160 includes a third intermediate element 161 and a third supporting portion 162. The third intermediate element 161 may have a spherical shape, for example, the third intermediate element 161 may be a ball. The third supporting portion 162 corresponds to the third intermediate element 161, and the third intermediate element 161 is movable relative to the third supporting portion 162. For example, the third intermediate element 161 may move along the optical axis OA relative to the third supporting portion 162.

The third supporting portion 162 may be located on the first movable part 120. The third supporting portion 162 includes a third supporting portion first surface 1621 and a third supporting portion second surface 1622. The third supporting portion first surface 1621 and the third supporting portion second surface 1622 face different directions, and the third supporting portion first surface 1621 and the third supporting portion second surface 1622 are in direct contact with the third intermediate element 161.

When viewed along the first direction D1, the third supporting assembly 160 is located between the first side 110a1 of the fixed part 110 and the optical axis OA. The distance between the third supporting assembly 160 and the first side 110a1 is smaller than the distance between the third supporting assembly 160 and the second side 110a2. That is, the third supporting assembly 160 is close to the first side 110a1 and away from the second side 110a2.

Please refer to FIG. 5, FIG. 6 and FIG. 7 at the same time. The first supporting portion first surface 1521 and the third supporting portion first surface 1621 face the same direction; the first supporting portion first surface 1521 and the second supporting portion first surface 1571 and the third supporting portion second surface 1622 face different directions.

The first supporting portion second surface 1522 and the third supporting portion second surface 1622 face the same direction; the first supporting portion second surface 1522 faces different directions from the second supporting portion first surface 1571 and the third supporting portion first surface 1621.

The second supporting portion first surface 1571 faces different directions from the third supporting portion first surface 1621 and the third supporting portion second surface 1622. In this way, the first intermediate element 151, the second intermediate element 156 and the third intermediate element 161 may be effectively restricted to prevent the first intermediate element 151, the second intermediate element 156 and the third intermediate element 161 from being moving towards an unwanted direction (for example, the second direction D2).

Please continue to refer to FIG. 5, FIG. 6 and FIG. 7. Since both the first supporting portion first surface 1521 and the first supporting portion second surface 1522 are in direct contact with the first intermediate element 151, the number of the contact portion for the first supporting portion 152 and the first intermediate element 151 is 2; since the second supporting portion first surface 1571 is in direct contact with the second intermediate element 156, the number of the contact portion for the second supporting portion 157 and the second intermediate element 156 is 1; since both the third supporting portion first surface 1621 and the third supporting portion second surface 1622 are in direct contact with the third intermediate element 161, the number of the contact portion for the third supporting portion 162 and the third intermediate element 161 is 2.

That is, the number of contact portion for the first supporting portion 152 and the first intermediate element 151 is different from the number of contact portion for the second supporting portion 157 and the second intermediate element 156; and the number of contact portion for the first supporting portion 152 and the first intermediate element 151 is greater than the number of contact portion for the second supporting portion 157 and the second intermediate element 156.

The number of contact portion for the first supporting portion 152 and the first intermediate element 151 is equal to the number of contact portion for the third supporting portion 162 and the third intermediate element 161, and both the number of contact portion for the first supporting portion 152 and the first intermediate element 151 and the number of contact portion for the third supporting portion 162 and the third intermediate element 161 is 2.

The number of contact portion for the third supporting portion 162 and the third intermediate element 161 is different from the number of contact portion for the second supporting portion 157 and the second intermediate element 156; and the number of contact portion for the third supporting portion 162 and the third intermediate element 161 is greater than the number of contact portion for the second supporting portion 157 and the second intermediate element 156. In this way, it may be helpful to assemble the optical element driving mechanism 100. Moreover, the optical element driving mechanism 100 may be made more stable.

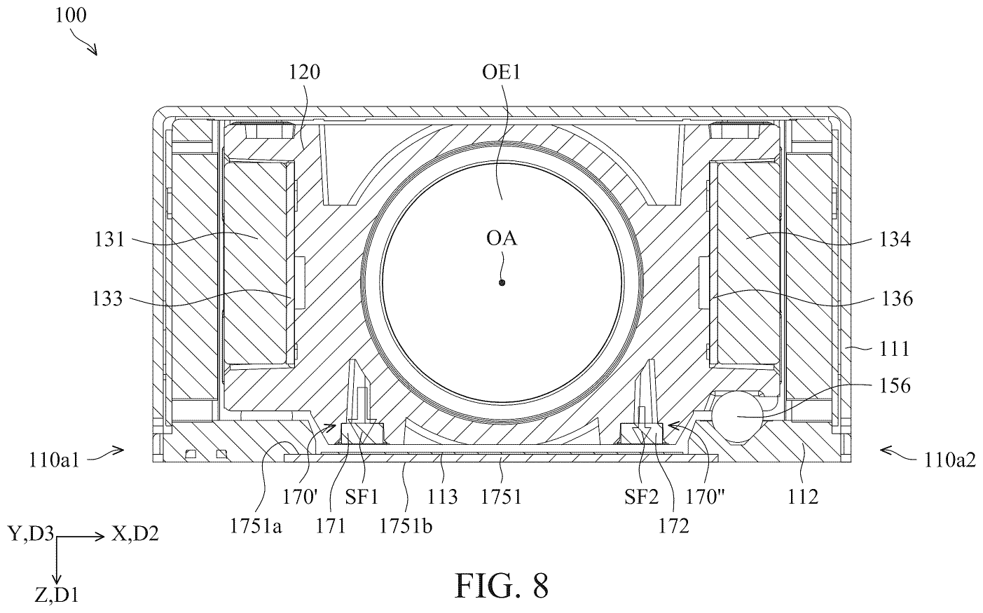

Please refer to FIG. 8. FIG. 8 is a cross-sectional view along line E-E′ of FIG. 2 of the optical element driving mechanism 100, the first optical element OE1 and the second optical element OE2 according to some embodiments of the present disclosure.

The first stabilizing element 171 and the second stabilizing element 172 of the stabilizing assembly 170 may be magnets. The first stabilizing element 171 and the second stabilizing element 172 are disposed adjacent to the fixed part magnetic conductive element 113 that is made of magnetic conductive material, and the first stabilizing element 171 and the second stabilizing element 172 are disposed on the first movable part 120.

Therefore, the first stabilizing element 171 generates a first stabilizing force SF1 (indicated by an arrow) on the first movable part 120 to act on a first acting part 170′, and the second stabilizing element 172 generates a second stabilizing force SF2 (indicated by an arrow) on a second acting part 170″.

As shown in FIG. 8, when viewed along the first direction D1, the first stabilizing element 171 and the first acting part 170′ are located between the optical axis OA and the first side 110a1 of the fixed part 110; and when viewed along the first direction D1, the second stabilizing element 172 and the second acting part 170″ are between the optical axis OA and the second side 110a2 of the fixed part 110.

According to some embodiments of the present disclosure, the magnetic strength of the first stabilizing element 171 is different from the magnetic strength of the second stabilizing element 172. In detail, according to some embodiments of the present disclosure, the magnetic strength of the first stabilizing element 171 is greater than the magnetic strength of the second stabilizing element 172.

According to some embodiments of the present disclosure, the intensity of the first stabilizing force SF1 is different from the intensity of the second stabilizing force SF2. In detail, according to some embodiments of the present disclosure, the intensity of the first stabilizing force SF1 is greater than the intensity of the second stabilizing force SF2.

Since the magnetic strength of the second driving magnet 134 that is adjacent to the second side 110a2 and the magnetic strength of the second stabilizing element 172 are smaller than the magnetic strength of the first driving magnet 131 that is adjacent to the first side 110a1 and the magnetic strength of the first stabilizing element 171; therefore, the magnetic influence on the second side 110a2 is smaller than the magnetic influence on the first side 110a1. In this way, the external device at the second side 110a2 may be prevented from being affected by the magnetic force of the second driving magnet 134 and the second stabilizing element 172, so that the external device may be disposed at the second side 110a2.

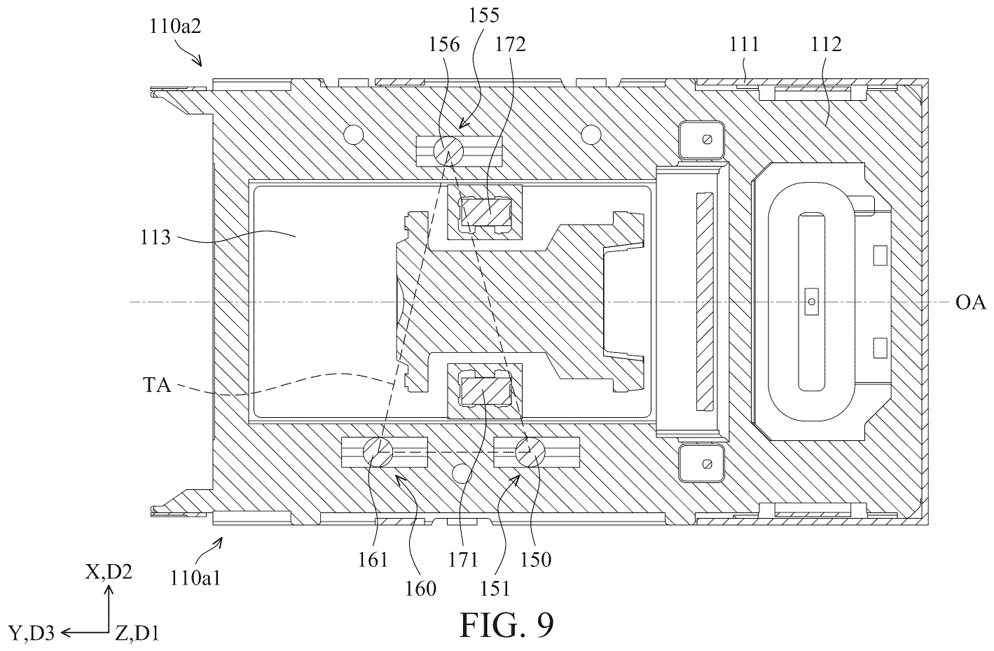

Please refer to FIG. 9. FIG. 9 is a cross-sectional view along line F-F′ of FIG. 2 of the optical element driving mechanism 100, the first optical element OE1 and the second optical element OE2 according to some embodiments of the present disclosure.

As shown in FIG. 9, when viewed along the first direction D1, the distance between the first stabilizing element 171 and the second supporting assembly 155 is greater than the distance between the first stabilizing assembly 171 and the first supporting assembly 150 and the distance between the first stabilizing assembly 171 and the third supporting assembly 160.

Furthermore, when viewed along the first direction D1, the first supporting assembly 150, the second supporting assembly 155, and the third supporting assembly 160 may form a triangle (indicated by a dotted line) TA, and the first stabilizing element 171 is disposed in the triangle TA.

As a result, the first stabilizing force SF1 (please refer to FIG. 8) generated by the first stabilizing element 171 on the first movable part 120 is also located in the triangle TA; therefore, the first supporting assembly 150, the second supporting assembly 155, and the third supporting assembly 160 may stably support the first stabilizing force SF1, making the structure of the optical element driving mechanism 100 more stable.

Please continue to refer to FIG. 9, when viewed along the first direction D1, the distance between the second stabilizing element 172 and the second supporting assembly 155 is smaller than the distance between the second stabilizing element 172 and the first supporting assembly 150 and the distance between the second stabilizing element 172 and the third supporting assembly 160.

Furthermore, since the second stabilizing force SF2 (please refer to FIG. 8) generated by the second stabilizing element 172 on the first movable part 120 is small, the second stabilizing element 172 may not be disposed in the triangle TA.

In this way, in addition to balancing the stabilizing force exerted on the first movable part 120 to make the optical element driving mechanism 100 more stable, the degree of freedom in manufacturing the optical element driving mechanism 100 may also be increased.

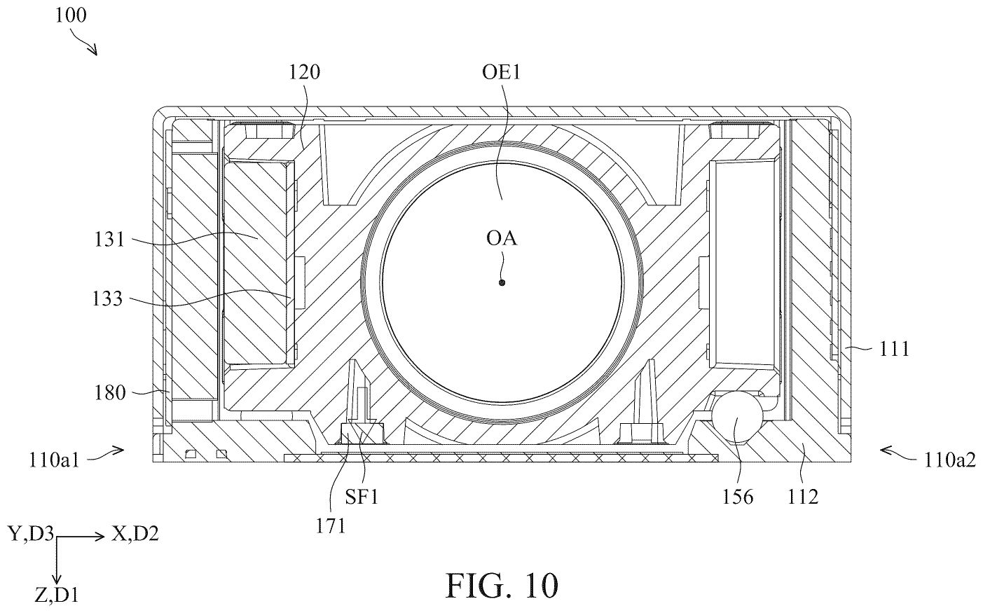

Please refer to FIG. 10. FIG. 10 is a modified embodiment of the optical element driving mechanism 100, the first optical element OE1 and the second optical element OE2 in FIG. 8.

In FIG. 10, the optical element driving mechanism 100 does not have the second driving magnet 134, the second driving coil 135, the second magnetic isolation element 136, and/or the second stabilizing element 172. Therefore, the second side 110a2 of the fixed part 110 does not have magnetic force, so that the second side 110a2 is not affected by the magnetic force.

In FIG. 10, the second driving force F2 is zero, and the second stabilizing force SF2 is also zero. The first movable part 120 is driven by the first driving force F1 only, and the first movable part 120 is fixed by the first stabilizing force SF1 only. In this way, the number of elements of the optical element driving mechanism 100 may be reduced, thereby making the optical element driving mechanism 100 lighter and smaller. Furthermore, the external elements at the second side 110a2 may be prevented from being affected by magnetic force, so that the external devices may be disposed at the second side 110a2.

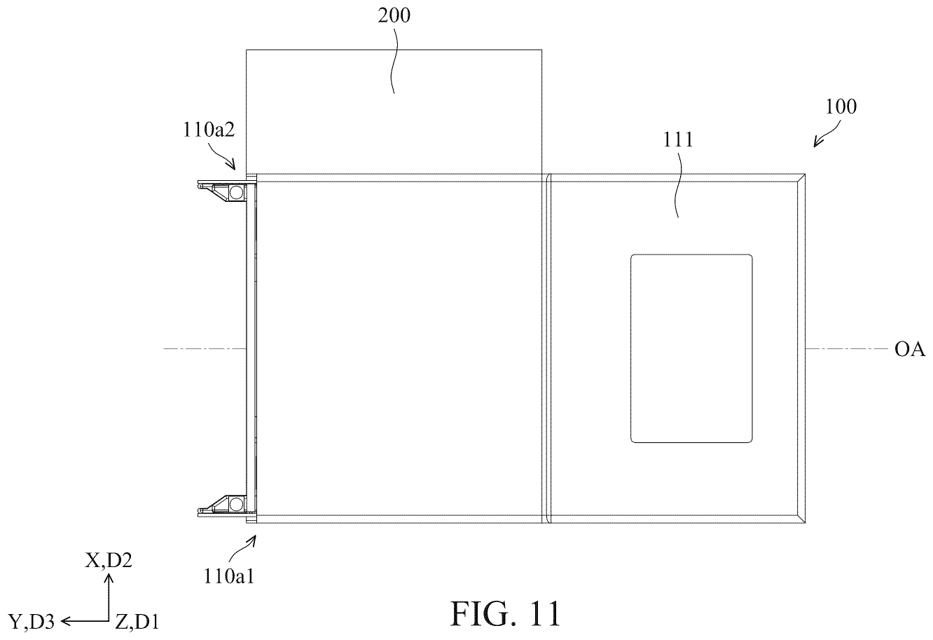

Please refer to FIG. 11. FIG. 11 is a top view of the optical element driving mechanism 100, the external device 200, the first optical element OE1 and the second optical element OE2 according to some embodiments of the present disclosure.

When viewed along the first direction D1, the external device 200 may be disposed adjacent to the second side 110a2 without being subject to excessive magnetic interference. According to some embodiments of the present disclosure, the external device 200 may be another optical module, an antenna, a vibration motor, etc.

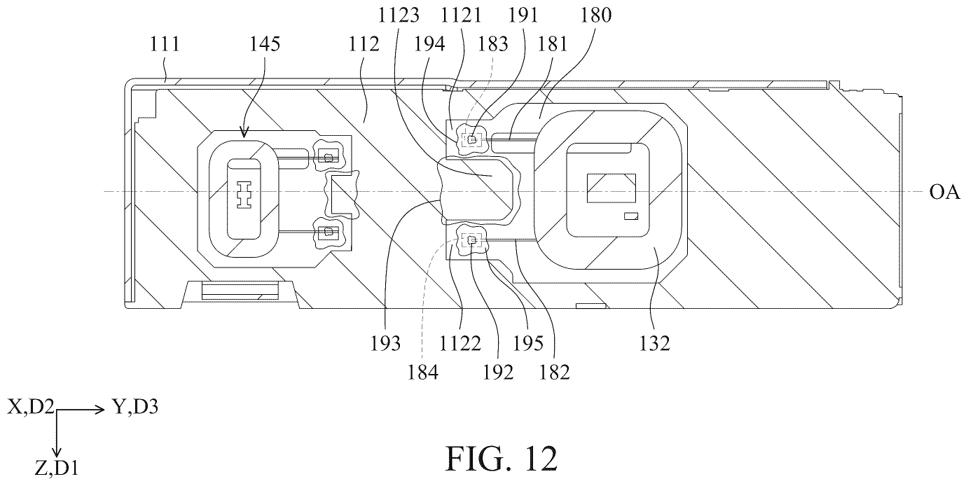

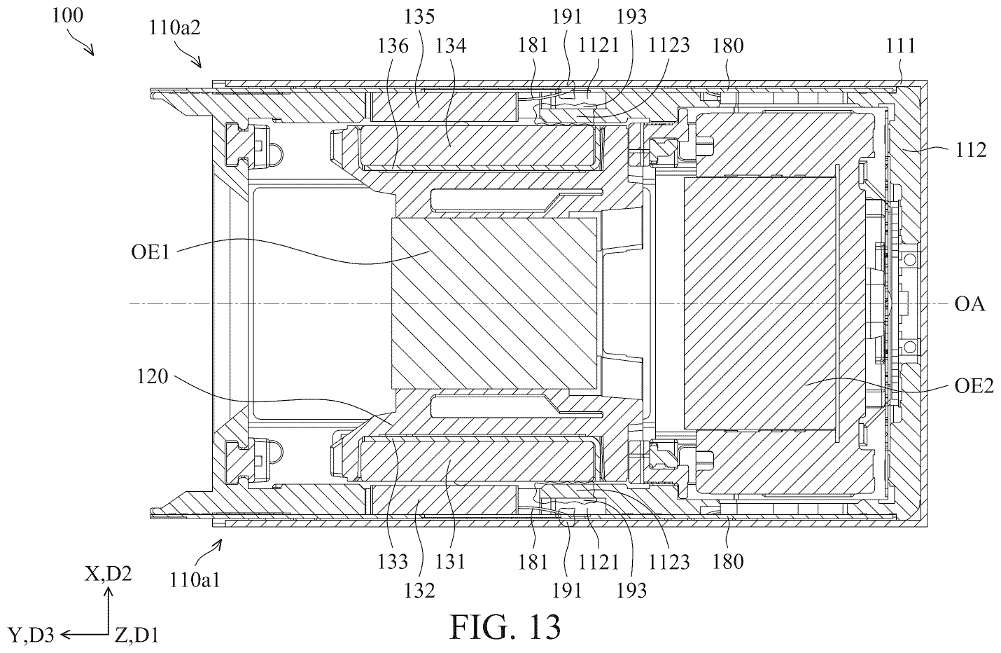

Please refer to FIG. 12 and FIG. 13. FIG. 12 is a cross-sectional view along line G-G′ of FIG. 2 of the optical element driving mechanism 100, the first optical element OE1 and the second optical element OE2 according to some embodiments of the present disclosure. FIG. 13 is a cross-sectional view along line H-H′ of FIG. 2 of the optical element driving mechanism 100, the first optical element OE1 and the second optical element OE2 according to some embodiments of the present disclosure.

The circuit assembly 180 includes a first lead 181, a second lead 182, a first circuit assembly connecting portion 183, and a second circuit assembly connecting portion 184. Furthermore, the first circuit assembly connecting portion 183 and the second circuit assembly connecting portion 184 have a plate-like structure.

The circuit assembly 180 is disposed on the base 112 of the fixed part 110. The base 112 includes a first groove 1121, a second groove 1122, and a groove spacer 1123. Moreover, the connecting assembly 190 includes a first connecting element 191, a second connecting element 192, a third connecting element 193, a fourth connecting element 194, and a fifth connecting element 195.

As shown in FIGS. 12 and 13, the groove spacer 1123 is located between the first groove 1121 and the second groove 1122. The first groove 1121 corresponds to the first lead 181, and the second groove 1122 corresponds to the second lead 182. In detail, the first lead 181 is provided in the first groove 1121 and the second lead 182 is provided in the second groove 1122.

The first groove 1121 and the second groove 1122 are formed on the surface of the base 112 that is facing away (parallel to the second direction D2, or −X axis) from the first movable part 120 (that is, the first groove 1121 and the second groove 1122 is formed on the outward-facing surface).

The base 112 is at least partially located between the first lead 181 and the first movable part 120; and the base 112 is at least partially located between the second lead 182 and the first movable part 120. That is, the first groove 1121 and the second groove 1122 do not penetrate the base 112 in the second direction D2.

In this way, the structure of the base 112 may be enhanced, and the first lead 181 and the second lead 182 may be accommodated at the same time, making the electrical circuit of the optical element driving mechanism 100 more stable.

As shown in FIG. 12 and FIG. 13, the first lead 181 is connected to the first circuit assembly connecting portion 183 of the circuit assembly 180 via the first connecting element 191, and the second lead 182 is connected to the second circuit element connecting portion 184 via the second connecting element 192; in this way, the connection from the first lead 181 and the second lead 182 to the first circuit element connecting portion 183 and the second circuit element connecting portion 184 may be made more stable. The groove spacer 1123 is connected to the first circuit assembly connecting portion 183 and the second circuit assembly connecting portion 184 via the third connecting element 193. The first circuit assembly connecting portion 183 is connected to the base 112 via the fourth connecting element 194, and the second circuit assembly connecting portion 184 is connected to the base 112 via the fifth connecting element 195; in this way, the first circuit assembly connecting portion 183 and the second circuit assembly connecting portion 184 are fixed to the base 112 and may protect the first lead 181 and the second lead 1 82 from oxidation. According to some embodiments of the present disclosure, the first connecting element 191, the second connecting element 192, the third connecting element 193, the fourth connecting element 194, and the fifth connecting element 195 may be conductive glue or solder to effectively electrically connect the elements to desired place.

According to some embodiments of the present disclosure, the first connecting element 191 is in direct contact with the second connecting element 192. According to some embodiments of the present disclosure, the first connecting element 191 is in direct contact with the third connecting element 193. According to some embodiments of the present disclosure, the first connecting element 191 is in direct contact with the fourth connecting element 194.

According to some embodiments of the present disclosure, the first connecting element 191, the second connecting element 192, the third connecting element 193, the fourth connecting element 194, and the fifth connecting element 195 may be arranged in sequence. In detail, the first connecting element 191, the second connecting element 192, the third connecting element 193, the fourth connecting element 194, and the fifth connecting element 195 are provided in the optical element driving mechanism 100 at different time.

According to some embodiments of the present disclosure, multiple of the first connecting element 191, the second connecting element 192, the third connecting element 193, the fourth connecting element 194, and the fifth connecting element 195 may be provided at the same time. In detail, a plurality of the first connecting element 191, the second connecting element 192, the third connecting element 193, the fourth connecting element 194, and the fifth connecting element 195 may be provided to the optical element driving mechanism 100 at the same time.

According to some embodiments of the present disclosure, all of the first connecting element 191, the second connecting element 192, the third connecting element 193, the fourth connecting element 194, and the fifth connecting element 195 may be provided simultaneously. In detail, all of the first connecting element 191, the second connecting element 192, the third connecting element 193, the fourth connecting element 194, and the fifth connecting element 195 may be provided to the optical element driving mechanism 100 at the same time.

According to some embodiments of the present disclosure, the first connecting element 191 and the second connecting element 192 have an integrally formed structure (for example, the first connecting element 191 and the second connecting element 192 may be in contact with each other or be integrated). According to some embodiments of the present disclosure, multiple of the first connecting element 191, the second connecting element 192, the third connecting element 193, the fourth connecting element 194, and the fifth connecting element 195 have an integrally formed structure. According to some embodiments of the present disclosure, all of the first connecting element 191, the second connecting element 192, the third connecting element 193, the fourth connecting element 194, and the fifth connecting element 195 have an integrally formed structure. The integrally formed connecting element may facilitate the assembly of the optical element driving mechanism 100 and may make the optical element driving mechanism 100 more stable. According to some embodiments of the present disclosure, the first connecting element 191, the second connecting element 192, the third connecting element 193, the fourth connecting element 194, and the fifth connecting element 195 may be insulated glue, so that the integrally formed connecting elements will not causing a short circuit.

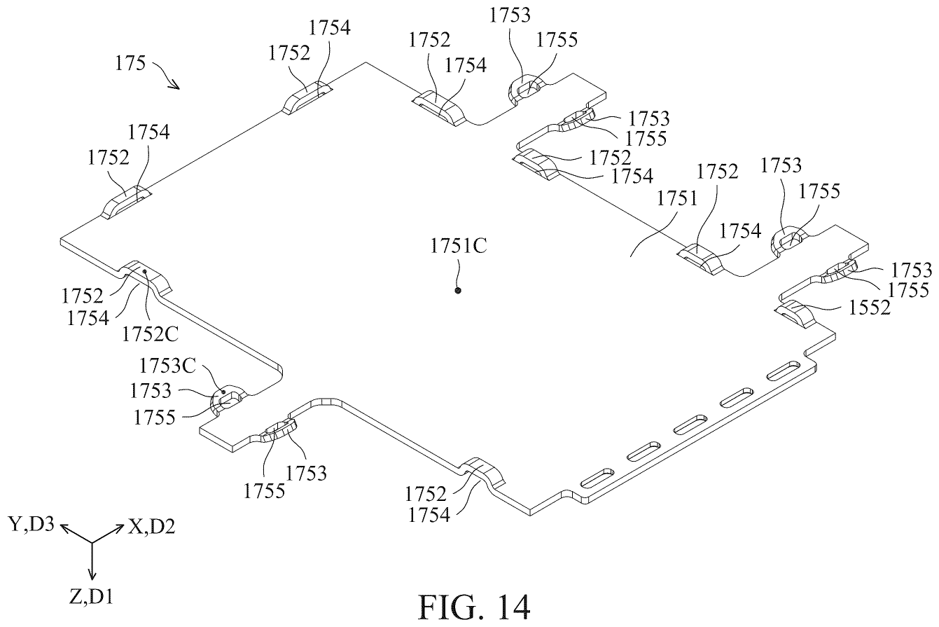

Please refer to FIG. 14, FIG. 14 is a perspective view of the reinforcing assembly 175 of the optical element driving mechanism 100 according to some embodiments of the present disclosure.

As shown in FIG. 14, the reinforcing assembly 175 includes a reinforcing body 1751, a first reinforcing portion 1752, a second reinforcing portion 1753, a first opening 1754, and a second opening 1755.

The reinforcing body 1751, the first reinforcing portion 1752, and the second reinforcing portion 1753 have a plate-like structure. The first opening 1754 is formed between the reinforcing body 1751 and the first reinforcing portion 1752. The second opening 1755 is formed between the reinforcing body 1751 and the second reinforcing portion 1753. A part (or material) of the base 112 may be embedded in the first opening 1754 and the second opening 1755 to make the combination of the base 112 and the reinforcing assembly 175 more stable.

When viewed along the direction that is perpendicular to the first direction D1, the upper surface of the first reinforcing portion 1752 is parallel to the reinforcing body 1751. The upper surface of the second reinforcing portion 1753 is not parallel to the reinforcing body 1751. The first reinforcing portion 1752 and the second reinforcing portion 1753 are not parallel.

As shown in FIG. 14, along the thickness direction (the first direction D1) of the reinforcing body 1751, a center 1751C of the reinforcing body 1751 and a center 1752C of the first reinforcing portion 1752 have a distance greater than zero. That is, the reinforcing body 1751 and the first reinforcing portion 1752 are at different heights. The first reinforcing portion 1752 and the reinforcing body 1751 are integrally formed, and the first reinforcing portion 1752 is an arched structure protruding from the surface of the reinforcing body 1751 along the first direction D1.

Along the thickness direction (the first direction D1) of the reinforcing body 1751, a center 1753C of the second reinforcing portion 1753 and the center 1752C of the first reinforcing portion 1752 have a distance greater than zero. That is, the first reinforcing portion 1752 and the second reinforcing portion 1753 are at different heights. The second reinforcing portion 1753 and the reinforcing body 1751 are integrally formed, and the second reinforcing portion 1753 is an arched structure protruding from the surface of the reinforcing body 1751 in a direction that is greater than 0 degrees to the first direction D1. Since the first reinforcing portion 1752 and the second reinforcing portion 1753 present different angles and heights, the first reinforcing portion 1752 and the second reinforcing portion 1753 may withstand impacts from different directions, so that the optical element driving mechanism 100 may be more stable.

The first reinforcing portion 1752 is at least partially buried in the base 112. In detail, the base 112 covers the first reinforcing portion 1752, and the first reinforcing portion 1752 is not exposed from the base 112. The second reinforcing portion 1753 is at least partially buried in the base 112. In detail, the base 112 covers the second reinforcing portion 1753, and the second reinforcing portion 1753 is not exposed from the base 112.

Please return to FIG. 8. The reinforcing body 1751 includes a first reinforcing body surface 1751a and a second reinforcing body surface 1751b.

The first reinforcing body surface 1751a is exposed from the base 112, and a second reinforcing body surface 1751b is exposed from the base 112. The first reinforcing body surface 1751a and the second reinforcing body surface 1751b face opposite directions, and the first reinforcing body surface 1751a and the second reinforcing body surface 1751b are arranged along the thickness direction (the first direction D1) of the reinforcing body 1751.

In this way, the heat dissipation efficiency may be increased, and making the optical element driving mechanism 100 more stable.

In general, the first driving assembly 130, the second driving assembly 145, the first supporting assembly 150, the second supporting assembly 155, the third supporting assembly 160 and the stabilizing assembly 170 of the optical element driving mechanism 100 of the present disclosure are disposed at a distance away from the optical axis OA (that is, off-center) so that the optical element driving mechanism 100 may accommodate the first movable part 120 without increasing the height (in the first direction D1). Moreover, the present disclosure also has the effects of increasing stability and miniaturization.

Although embodiments of the present disclosure and their advantages have been described in detail, it should be understood that various changes, substitutions and alterations may be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps. In addition, the scope of the present disclosure is defined by the scope of the appended claims. In addition, each scope of the claims is constructed as a separate embodiment, and various combinations of the claims and combinations of embodiments are within the scope of the present disclosure.

What is claimed is:

1. An optical element driving mechanism, comprising:
a first movable part, connected to a first optical element;
a fixed part, wherein the first movable part is movable relative to the fixed part; and
a first driving assembly, driving the first movable part to move.

2. The optical element driving mechanism as claimed in claim 1,
wherein when viewed along a first direction that is perpendicular to an optical axis, the fixed part has a polygonal structure, and the fixed part comprises:
a first side, extending along the optical axis; and
a second side, extending along the optical axis,
wherein when viewed along the first direction, the first side and the second side are located on both sides of the optical axis, respectively,
wherein when a first driving current is input to the first driving assembly, the first driving assembly generates a first driving force on a first force bearing part of the first movable part, and
wherein when viewed along the first direction, the first force bearing part is located between the first side and the optical axis.

3. The optical element driving mechanism as claimed in claim 2,
wherein when the first driving current is input to the first driving assembly, the first driving assembly generates a second driving force on a second force bearing part of the first movable part,
wherein when viewed along the first direction, the second force bearing part is located between the optical axis and the second side,
wherein when viewed along the first direction, the first force bearing part is closer to the first side than the second force bearing part,
wherein the intensity of the first driving force is different from the intensity of the second driving force, and
wherein when viewed along the first direction, an external device is adjacent to the second side.

4. The optical element driving mechanism as claimed in claim 3,
wherein the second driving force is zero.

5. The optical element driving mechanism as claimed in claim 2, further comprising:
a first supporting assembly, supporting the first movable part, wherein the first supporting assembly comprises:
a first intermediate element; and
a first supporting portion, corresponding to the first intermediate element, and the first intermediate element is movable relative to the first supporting portion;
wherein the first supporting portion comprises:
a first supporting portion first surface, in direct contact with the first intermediate element; and
a first supporting portion second surface, in direct contact with the first intermediate element, wherein the first supporting portion second surface and the first supporting portion first surface face different directions,
wherein when viewed along the first direction, the first supporting assembly is located between the first side and the optical axis.

6. The optical element driving mechanism as claimed in claim 5, further comprising:
a second supporting assembly, supports the first movable part, wherein the second supporting assembly comprises:
a second intermediate element; and
a second supporting portion, corresponding to the second intermediate element, and the second intermediate element is movable relative to the second supporting portion,
wherein the second supporting portion comprising a second supporting portion surface that is in direct contact with the second intermediate element,
wherein the second supporting portion surface and the first supporting portion first surface face different directions,
wherein the second supporting portion surface and the first supporting portion second surface face different directions,
wherein when viewed along the first direction, the second supporting assembly is located between the second side and the optical axis, and
wherein the number of the contact portion for the first supporting portion and the first intermediate element is different from the number of the contact portion for the second supporting portion and the second intermediate element.

7. The optical element driving mechanism as claimed in claim 6, further comprising:
a third supporting assembly, supports the first movable part, wherein the third supporting assembly comprises:
a third intermediate element; and
a third supporting portion, corresponding to the third intermediate element, and the third intermediate element is movable relative to the third supporting portion,
wherein the third supporting portion comprises:
a third supporting portion first surface, in direct contact with the third intermediate element; and
a third supporting portion second surface, in direct contact with the third intermediate element,
wherein the third supporting portion first surface and the third supporting portion second surface face different directions.

8. The optical element driving mechanism as claimed in claim 7,
wherein the second supporting portion surface and the third supporting portion first surface face different directions,
wherein the third supporting portion first surface and the first supporting portion first surface face the same direction, and
wherein when viewed along the first direction, the third supporting assembly is located between the first side and the optical axis.

9. The optical element driving mechanism as claimed in claim 2, further comprising:
a stabilizing assembly, stabilizing the first movable part, comprising:
a first stabilizing element, generating a first stabilizing force on the first movable part to act on a first acting part; and
a second stabilizing element, generating a second stabilizing force on the first movable part to act on a second acting part,
wherein when viewed along the first direction, the first acting part is located between the optical axis and the first side,
wherein when viewed along the first direction, the second acting part is located between the optical axis and the second side, and
wherein the intensity of the first stabilizing force is different from the intensity of the second stabilizing force.

10. The optical element driving mechanism as claimed in claim 2,
wherein the first driving assembly further comprises:
a first driving coil;
a first driving magnet, having a first driving magnet first surface facing the first driving coil; and
a first magnetic isolation element, corresponding to the first driving magnet and having a magnetically conductive material,
wherein when viewed along the first direction, the first driving coil is located on the first side,
wherein a first magnetic isolation element first magnetic isolation part of the first magnetic isolation element has a plate-like structure, and
wherein when viewed in a direction that is perpendicular to the first driving magnet first surface, the first magnetic isolation element first magnetic isolation part does not overlap with the first driving magnet.

11. The optical element driving mechanism as claimed in claim 10,
wherein a first magnetic isolation element second magnetic isolation part of the first magnetic isolation element has a plate-like structure, and the first magnetic isolation element second magnetic isolation part is not parallel to the first magnetic isolation element first magnetic isolation part,
wherein when viewed in a direction that is perpendicular to the first driving magnet first surface, the first magnetic isolation element second magnetic isolation part at least partially overlaps the first driving magnet, and
wherein the first magnetic isolation element first magnetic isolation part and the first magnetic isolation element second magnetic isolation part are parallel to the first direction.

12. The optical element driving mechanism as claimed in claim 10, further comprising:
a second movable part, movable relative to the fixed part; and
a second driving assembly, driving the second movable part,
wherein the first magnetic isolation element first magnetic isolation part is located between the first driving magnet and the second driving assembly,
wherein a first driving magnet second surface of the first driving magnet faces the first magnetic isolation element,
wherein a first driving magnet third surface of the first driving magnet faces the first magnetic isolation element, and
wherein the first magnetic isolation element does not correspond to a first driving magnet fourth surface of the first driving magnet.

13. The optical element driving mechanism as claimed in claim 2, further comprising:
a circuit assembly, connected to an external circuit, and the circuit assembly comprises:
a first lead;
a second lead; and
a first circuit assembly connecting portion; and
a second circuit assembly connecting portion,
wherein the circuit assembly is arranged on a base of the fixed part, wherein the base comprises:
a first groove, corresponding to the first lead of the circuit assembly;
a second groove, corresponding to the second lead of the circuit assembly; and
a groove spacer, located between the first groove and the second groove,
wherein the first lead is connected to the first circuit assembly connecting portion of the circuit assembly through a first connecting element.

14. The optical element driving mechanism as claimed in claim 13,
wherein the first circuit assembly connecting portion and the second circuit assembly connecting portion have plate-like structures,
wherein the second lead is connected to the second circuit assembly connecting portion via a second connecting element,
wherein the groove spacer portion is connected to the first circuit assembly connecting portion via a third connecting element,
wherein the first circuit element connecting portion is connected to the base via a fourth connecting element,
wherein the first connecting element is in direct contact with the third connecting element,
wherein the first connecting element is in direct contact with the second connecting element, and
wherein the first connecting element is in direct contact with the fourth connecting element.

15. The optical element driving mechanism as claimed in claim 14,
wherein the first connecting element and the second connecting element have an integrally formed structure,
wherein the first groove is formed on a surface of the base that is facing away from the first movable part, and
wherein the base is at least partially located between the first lead and the first movable part.

16. The optical element driving mechanism as claimed in claim 2, further comprising:
a reinforcing assembly, made of metal, comprising:
a reinforcement body with plate-like structure;
a first reinforcing portion with a plate-like structure;
a first opening formed between the reinforcing body and the first reinforcing portion,
a second reinforcing portion having a plate-like structure; and
a second opening formed between the reinforcing body and the second reinforcing portion,
wherein the first reinforcing portion is parallel to the reinforcing body,
wherein along the thickness direction of the reinforcing body, a center of the reinforcing body and a center of the first reinforcing portion have a distance greater than zero,
wherein along the thickness direction of the reinforcing body, a center of the second reinforcing portion and the center of the first reinforcing portion have a distance greater than zero,
wherein the second reinforcing portion is not parallel to the reinforcing body,
wherein the first reinforcing portion and the second reinforcing portion are not parallel to each other,
wherein the first reinforcing portion is at least partially embedded in the base, and
wherein the second reinforcing portion is at least partially embedded in the base.

17. The optical element driving mechanism as claimed in claim 16,
wherein a first reinforcing body surface of the reinforcing body is exposed from the base;
wherein a second reinforcing body surface of the reinforcing body is exposed from the base,
wherein the first reinforcing body surface and the second reinforcing body surface face opposite directions, and
wherein the first reinforcing body surface and the second reinforcing body surface are arranged along the thickness direction of the reinforcing body.

18. The optical element driving mechanism as claimed in claim 2, further comprising:
a first supporting assembly, supporting the first movable part;
a second supporting assembly, supporting the first movable part;
a third supporting assembly, supporting the first movable part; and
a stabilizing assembly, stabilizing the first movable part, comprising:
a first stabilizing element, located between the first side and the optical axis.

19. The optical element driving mechanism as claimed in claim 18,
wherein the first stabilizing element is disposed in a triangle formed by the first supporting assembly, the second supporting assembly, and the third supporting assembly, and
wherein the distance between the first stabilizing element and the second supporting assembly is greater than the distance between the first stabilizing element and the first supporting assembly and the distance between the first stabilizing element and the third supporting assembly.

20. The optical element driving mechanism as claimed in claim 18,
wherein the stabilizing assembly comprises:
a second stabilizing element, located between the second side and the optical axis,
wherein the distance between the second stabilizing element and the second supporting assembly is smaller than the distance between the second stabilizing element and the first supporting assembly and the distance between the second stabilizing element and the third supporting assembly.
